(19) United States
(12) Patent Application Publication
(10) Pub. No.: US 2013/0261238 A1
(43) Pub. Date: Oct. 3, 2013

(54) Coating and Adhesive Compositions with Reduced Freeze/Thaw Degradation

(71) Applicant: Juan Arango, Chatsworth, GA (US)

(72) Inventor: Juan Arango, Chatsworth, GA (US)

(21) Appl. No.: 13/435,149

(22) Filed: Mar. 30, 2012

(51) Int. Cl. C08K 5/21; C08K 3/28

(52) U.S. Cl. 524/215

(57) ABSTRACT

Coating and adhesive compositions are disclosed comprising between approximately 2% to approximately 10% of urea added to latex-based compositions to prevent deterioration of the working quality of the compositions after being subjected to freeze/thaw cycles. Best results are obtained by dissolving the urea in water prior to the addition of other components, although urea may be added at other points in the mixing process.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to property-preserved paints and adhesives, and more specifically to compositions of latexes in water that retain their physical properties, such as flow and homogeneity, after several freeze-thaw cycles.

2. Description of Related Art

Synthetically manufactured polymers, such as latexes, are made in reactors by different technologies, such as radical polymerization, poly-addition, poly-condensation, etc., and contain about 50% by weight water, emulsifiers, protective colloids, catalysts and monomers. The resulting products may be utilized with (such as with paints) or without (such as with adhesives) significant quantities of other materials, such as pigments and fillers.

Latexes come in many varieties, namely, for exemplary purposes only, and without limitation, polyvinyl acetate, polyvinyl alcohol, styrene-acrylic, acrylic, vinyl acetate ethylene copolymer, styrene butadiene rubber, alkyds, epoxies and polyurethanes, and may be homo-polymers and/or copolymers. Paints or adhesives are emulsions or dispersions of latexes.

If such paints or adhesives are stored or maintained for a period of time at temperatures below 32° F. (0° C.), they freeze and become damaged, losing their flow characteristic and uniformity, often clumping, becoming cheese-like in appearance, hardening or coagulating. Such products are useless after freezing, particularly because their application requires smooth flow. Evidence of the effects of freezing can often be observed as a loss of the original “milky” appearance of the latex material.

For example, with water-based latex paints, subjecting the paint to temperatures below freezing causes the dispersion of pigments, fillers and latex to break up, and, upon thawing, the paints often exhibit undesirable characteristics, such as clumping, separation of components and poor flow. In order to overcome these difficulties, there are generally two approaches:
1. Prevent the composition from freezing, thus avoiding the problem altogether (which is the method typically utilized in Europe); and
2. Including an additive that helps retain the desired uniformity and flow characteristics of the paint.

While the first approach works quite well, it is subject to mistakes that allow accidental freezing, but more importantly, it is costly. The second approach has been utilized in the past by inclusion of volatile organic compounds (“VOCs”), that is, compounds with a high vapor pressure and low solubility, to the paint mixture. These VOCs both depress the freezing point, but more importantly, preserve the homogeneity of the mixture upon thawing after a freeze. Unfortunately, many VOCs have been banned from use, or subject to highly limited restrictions on concentration ranges that are ineffective.

Moreover, with the transition to more environmentally-responsible products (“green products”), there has been a move towards use of materials that contain fewer VOCs. Many systems that were once organic-based solvents are being converted to water-based solvent systems. Unfortunately, many of these water-based solvent systems still require some VOCs to stabilize their physical properties, such as their flow characteristics, particularly after a freeze-thaw cycle. The same problems occur with any products manufactured that contain latexes, such as, for exemplary purposes only, architectural paints, (interior and exterior grade), water-based adhesives, caulking compounds, water-proofing systems, etc.

Other than with retention above freezing temperatures, traditionally the problem of property loss after freezing has been solved by adding solvents, such as, for exemplary purposes only, propylene glycol, ethylene glycol, and other glycols, which unfortunately are listed as dangerous for humans and for the environment, often as carcinogenic. When utilizing these types of additives, the above-mentioned products are freeze/thaw stable, but they are not “green”, or “solvent-free” any more.

Therefore, it is readily apparent that there is a need for coatings and adhesives that do not suffer loss of appearance, properties or homogeneity after freeze/thaw cycling and which do not include VOCs.

### BRIEF SUMMARY OF THE INVENTION

Briefly described, in a preferred embodiment, the present invention overcomes the above-mentioned disadvantages and meets the recognized need by providing compositions and methods to eliminate the deleterious effects of freeze/thaw cycles for all types of latexes and water-based goods containing latexes as the main binder, such as paints (both interior and exterior grades), caulking compounds, water-based adhesives, water-proofing systems, other latex-based repair products, while obviating the need to use volatile organic compounds.

The preferred embodiment comprises addition of urea to a latex-based composition, preferably by dissolving urea, preferably as crystalline form, in water prior to the addition of other components. When added at beginning, the presence of urea also aids pigment and filler dispersion. Urea may be added at other points in the mixing process, but has the strongest benefits when dissolved first in water prior to addition of the other components of the composition.

Levels of between approximately 2% to approximately 10% have been found advantageous, with higher concentrations permitting more freeze/thaw cycles to be experienced without loss of properties of the composition. The addition of urea doesn't prevent freezing; however, it prevents the deleterious effects of freezing, allowing a composition to retain its original characteristics without significant degradation.

According to its major aspects and broadly stated, the present invention in its preferred form is a coating or adhesive composition with reduced freeze/thaw degradation, the composition comprising a water and latex mixture having between approximately 30% and approximately 70% solids and having at least 2% by weight urea therein, and, optionally, between approximately 1% and approximately 2% by weight of sodium nitrite therein. Preferably, the urea is between approximately 2% and approximately 10% by weight and is preferably mixed into water before adding the latex and other additives to prevent the deleterious effects of freeze/thaw cycles on the composition. The water and latex mixture further selectively includes fillers, pigments, emulsifiers and/or dispersants.

The composition is preferably formed from vinyl acetate latex, homo-polymers and co-polymers, polyvinyl alcohols, polyvinyl acetate, styrene/acrylic polymers, all-acrylics, ethylene vinyl acetate, styrene butadiene rubber latex, alkyd latexes, epoxy water-based emulsions and/or polyurethane water-based dispersions.

More specifically, the present invention is a coating or adhesive compositions with reduced freeze/thaw degradation comprising at least 2% of urea to stabilize a latex product for at least one (1) freeze/thaw cycle down to 15° F. To improve the composition to allow three (3) or more cycles to 0° F. and back to room temperature of 70° F., 4% of urea addition has been found advantageous. Lastly, with 5% or greater of urea, ten (10) or more freeze-thaw cycles at 0° F. may be sustained.

Preferably, between approximately 2% and approximately 10% urea is dissolved in water per 100 parts of final composition to be made, and pH is adjusted by means known in the art. Subsequently, latex, fillers, pigments, plasticizers, coalescing/film building agents, pH buffers, thickeners, tackifier resins and or defoamers are mixed into the urea/water solution. The final composition comprises between approximately 30% and approximately 70% solids, with the balance comprising water.

Accordingly, a feature and advantage of the present invention is its ability to prevent deterioration of physical properties of latex-based compositions after several freeze/thaw cycles.

Another feature and advantage of the present invention is its ability to maintain homogeneity of paint and/or adhesive compositions after they are subject to freezing temperatures.

Still another feature and advantage of the present invention is its ability to prevent clumping or hardening of latex-based compositions.

Yet another feature and advantage of the present invention is that it extends the open time (drying time) of the paints and provides a more homogeneous color distribution while painting.

Yet still another feature and advantage of the present invention is that the use of urea slightly reduces the viscosity of the composition and the pigments incorporate much easier, resulting in less mixing time being required with consequent energy savings.

A further feature and advantage of the present invention is its ability to raise the pH slightly, thus reducing the quantity of pH buffers required, reducing the need for strong, dangerous buffers, and thereby saving money.

Yet still a further feature and advantage of the present invention is that the scrub resistance of the paint will be improved.

These and other features and advantages of the present invention will become more apparent to one skilled in the art from the following description and claims.

### DETAILED DESCRIPTION OF THE PREFERRED EMBODIMENTS OF THE INVENTION

In describing the preferred embodiment, specific terminology is employed for the sake of clarity. The invention, however, is not intended to be limited to the specific terminology so selected, and it is to be understood that each specific element includes all technical equivalents that operate in a similar manner to accomplish similar functions. Further, it is to be understood that the compositions described below are not limited to specific compounds, synthetic methods, or uses.

In this specification and in the claims that follow, reference will be made to a number or terms that have the following meanings unless the context requires otherwise:

“Freeze/thaw” refers to the “cycles” of freezing and thawing that occur when water-based products undergo temperatures below 32° F. (0° C.). Water is the vehicle or component that freezes, and contains all polymeric particles “swimming” or “dispersed”, or “emulsified” in it.

“Latex” refers to polymers or emulsions/dispersions made from monomers, such as vinyl acetate monomer, butyl-acrylate monomer, 2-eha, styrene, butadiene, ethylene, comprising a range of glass temperatures, (“Tg”), from −50° C. to 100° C. Lower glass temperatures are often the softest monomers (for example −45° C., −40° C., −35° C.), and these type of polymers are utilized to make products such as tapes and labels. Polymers with glass temperatures around 0° C. to 20° C. are often utilized in the construction industry to make adhesives and/or caulks or paints. Polymers with higher Tg (30° C. to about 45° C.) are often utilized to make “hard” coatings, for example for some special paints, or paper/cardboard coatings, metal coatings, etc. These hard polymers mostly need either heat (hot air in an oven, or contact heat such as from a hot cylinder, or radiant heat from infra-red lamps, etc.) or need to be “softened” by utilizing so called “coalescent agents” (which are typically solvents) in order to build a continuous film. Otherwise, hard polymers are brittle or simply dry as a powder, but not as a film.

Frequently utilized monomers are, for exemplary purposes only and without limitation, butyl acrylate (ba), vinyl acetate monomer, 2-ethylhexyl acrylate (2-eha), styrene, methyl methacrylate (mma), butadiene, etc. Typically, polymers are made in a polymerisation process including one soft monomer (for exemplary purposes only, (butyl-acrylate) and one hard monomer (for exemplary purposes only, styrene) at 50% of each, or for example 40/60 or 60/40 etc.

2-eha is a very soft monomer and the polymers resulting out of using this monomer are mostly extremely soft, and are utilized as pressure sensitive adhesives, frequently to make tapes or labels. Other polymers, comprising mostly styrene or mma, can be very hard.

“Emulsifier” is an agent that stabilizes the latex and gives the actual homogeneous, “milky” appearance to these types of polymers. Emulsifiers utilized for the manufacturing of latexes are typically non-ionic or anionic nature. Typical emulsifiers include, without limitation, IGEPAL CO-530 from the Stepan Company, TRITON X-405 from the Dow Chemical Company and EMULPHOR OPS 25 from BASF.

“Emulsions/Dispersions” are manufactured starting out with monomers made compatible with water by means of emulsifiers, which stabilize the monomer/water emulsion. Exemplary monomers are those, for exemplary purposes only and without limitation, utilized to form the following polymers:
Vinyl acetate latex, homo-polymers and co-polymers, polyvinyl alcohols, polyvinyl acetate
Styrene/acrylic polymers
All-acrylics
Ethylene vinyl acetate, EVA
Styrene butadiene rubber latex, SBR
Alkyd latexes
Epoxy water-based emulsions
Polyurethane water-based dispersions

“Dispersion” and “emulsion” are utilized interchangeably herein.

“Derivatives” are finished products that are manufactured comprising latexes as their main binder, particularly, for exemplary purposes only and without limitation:
Water-based architectural paints, interior and exterior grade
Water-based caulking compounds
Water-based water-proofing systems
Water-based repair products
Water-based coatings for different materials like wood, metal, cardboard, textiles, sheetrock, etc.
Water-based roofing membranes
Water-based concrete modifiers
Water-based adhesives
Other products containing latexes

The above derivatives comprise, for exemplary purposes only and without limitation:
Water as the carrier or vehicle
Latexes as the binding material
Inorganic fillers
Pigments
Thickeners
Plasticizers
pH buffers
Biocides
Other auxiliary materials, such as solvents to overcome the freeze/thaw problem.

“Cycles”, means exposure for 12 hours in a freezer at one specific testing temperature, for example 0° F. Subsequently, the product as allowed to thaw at, typically, room temperature (approximately 70° F.). For actual situations, these times and temperatures are unpredictable.

However, lab conditions are mostly controlled to approximate real situations, but not the often accidental situations during transportation of goods in the winter time. Freezing problems typically occur most often during transportation.

Moreover, during the first few hours (1 to 3), when a product is exposed to temperatures below the freezing point of water (32° F., 0° C.), the product will not typically become damaged. However after about 3 hours, a significant level of damage is observed. (The greater the combination of exposure to factors such as time and temperature, the more likely the product will be damaged.) For example, compositions with high solids are more likely to get damaged than those with lower solids. One explanation for this is that apparently reduced space exits between particles/molecules in high solids compositions which reduced space causes higher attraction between the particles/molecules and the compound becomes “hard”. This is increased if, simultaneously, the emulsifier content in the system is low (emulsifiers work as stabilizing agents), and if the freezing temperature is lower, and if the freezing time is longer.

The present invention in a preferred embodiment comprises latex-based compositions with urea added thereto. Urea (CO(NH₂)₂), is also referred to as carbamide. Urea has two amine groups joined by a carbonyl functional group. Thus it is a raw material highly rich in nitrogen. It can be produced as a solid or a liquid, not containing any solvents; it is colorless and odorless. In the presence of water it decomposes to ammonia and carbon dioxide with a resulting ammonia odor. It is non-toxic and has been widely utilized in the chemical industry for many purposes, such as, for exemplary purposes only, for organic syntheses. Friedrich Woehler, in 1828, synthesized urea for the first time from two inorganic materials. As a result of this discovery, Woehler is considered to be the “father of organic chemistry”. World-wide production of urea is predominantly (90%) utilized in the agricultural industry. Urea has a very high nitrogen content, approximately 46%. It also finds application in production of some types of adhesives, particularly utilized for the manufacture of plywood. Urea is also utilized in the cosmetic industry, as a component in animal feed, in the human food industry as a browning agent (such as, for production of pretzels), in skin creams, moisturizers, hair conditioners, in tooth whitening products, etc.

When urea is dissolved in water, it dissociates using energy (endothermic process). The water in which urea is dissolved gets extremely cold. The temperature depends on the amount of urea that is being dissolved in the water. When utilized as an additive to latexes or their derivatives, urea does not prevent freezing, but rather causes the latex or derivative to retain its original properties (milky, flowing liquid) permitting use after freezing without damage.

The percentage by weight is the amount of a component that needs to be added per 100 parts by weight of the final composition. The urea is preferably provided as a solution in water, which will be added to the composition. The percentage of urea in some cases is typically from 2% to 10%; in other cases 3% to 10%, in other cases 2% to 5%, and in others 2% to 4% urea in solid form. Factors that have an influence on the amount and the efficiency of urea added are, for exemplary purposes only and without limitation:
The particle size of the latex; most acrylics have smaller particle size (0.05 microns to 0.3 microns) than Vinyl-acetate latexes (0.5 microns to 1.5 microns)
Type of emulsifier; depends on the ionic nature; if non-ionic or anionic
The amount of the emulsifier
The solid content of the compound
The water content of the compound
The time that the compound has been exposed to freezing temperatures
The temperature below freezing point to which the compounds have been exposed
The monomeric composition of the latex
The glass temperature, Tg, of the latex. This tells us how soft or hard the latex is. The lower the number, (−50° C. for example for pressure sensitive adhesives), the softer the latex. The higher the number (100° C. for some styrene or methyl methacrylate based latexes), the harder the latex
Water solutions of synthetic polymers
Flow and other properties
Coatings, such as, for exemplary purposes only, paints, adhesives, caulking compounds and water-proofing
Property-preserved coatings and adhesives

In the preferred embodiment, between approximately 2% and approximately 10% urea is added by weight of the final composition to be made, and pH is adjusted by means known in the art.

Subsequently, latex, fillers (such as, for exemplary purposes only, calcium carbonate, kaolin or talc), pigments (such as, for exemplary purposes only, titanium dioxide), plasticizers, coalescing/filming agents (TEXANOL), pH buffers as are known in the art, thickeners (such as, for exemplary purposes only, acrylic, cellulosic, associative and similar), tackifier resins (for example rosin or hydrocarbon resins melted in low or high viscosity terpenic oils), defoamers (e.g., SURFYNOL MD 20) and other selected compounds are added, and the composition is mixed by high or low shear. The final composition comprises between approximately 30% and approximately 70% solids, with the balance comprising water.

Exemplars of latexes are, without limitation, ACRONAL 296 D, from BASF, UCAR 145 from Dow Chemical Company, SAITACK X-210-123E from Saiden Technologies, RHOPLEX N-619, from Dow Chemical Company (formerly Rohm and Haas).

Typically, preferably two 2% to 10% of urea is required to pass several cycles at 0° F. Preferably, 2% of urea has been found to stabilize a latex product for at least one freeze/thaw cycle down to 15° F. To improve the composition to allow it to sustain three (3) cycles to 0° F. and back to room temperature of 70° F., 4% of urea addition has been found advantageous. With 5% of urea, ten (10) freeze-thaw cycles at 0° F. may be sustained.

Selected examples of latex compositions containing urea as a property stabilizing agent are disclosed below:

### EXAMPLE I

| | |
|---|---|
| Water (Vehicle) | 21.2 |
| Rhodoline 111 (Pigment Dispersant) | 2.0 |
| AMP-95 (pH-Buffer) | 0.5 |
| Urea (Freeze/Thaw Degradation Stabilizer) | 2.5 |
| Calcium Carbonate (Filler) | 30.0 |
| TiO2 (Pigment) | 18.0 |
| Polyphase 678 (Fungicide) | 0.3 |
| Mergal K12N (Biocide) | 0.3 |
| Benzoflex 2088 (Plasticizer) | 2.0 |
| Surfynol MD 20 (Defoamer) | 0.2 |
| Acronal 296 D (Latex) | 20.0 |
| Ucar 146 (Thickener) | 3.0 |
| Total: | 100.0 |

Further, inclusion of small amounts of NaNO₂ (1-2% by weight) while not necessary has been found advantageous.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A composition comprising:
a water and latex mixture; and
urea.

2. The composition of claim 1, wherein said urea comprises at least 2% by weight of composition.

3. The composition of claim 1, wherein said urea comprises between approximately 2% and approximately 10% by weight of composition.

4. The composition of claim 1, further comprising sodium nitrite.

5. The composition of claim 4, wherein said sodium nitrite comprises between approximately 1% and approximately 2% by weight of composition.

6. The composition of claim 1, further comprising compounds selected from the group consisting of fillers, pigments, emulsifiers, dispersants, and combinations thereof.

7. The composition of claim 1, wherein said urea comprises approximately 2.5% by weight of composition.

8. The composition of claim 1, wherein said urea comprises approximately 4% by weight of composition.

9. The composition of claim 1, wherein said urea comprises approximately 5% by weight of composition.

10. The composition of claim 1, wherein said urea comprises approximately 10% by weight of composition.

11. The composition of claim 1, further comprising approximately 30% and approximately 70% solids.

12. The composition of claim 1, further comprising a dispersion of a material selected from the group consisting of vinyl acetate latex, homo-polymers and co-polymers, polyvinyl alcohols, polyvinyl acetate, styrene/acrylic polymers, all-acrylics, ethylene vinyl acetate, styrene butadiene rubber latex, alkyd latexes, epoxy water-based emulsions, polyurethane water-based dispersions, and combinations thereof.

13. A method for preventing degradation of latex-based compositions, said method comprising the steps of:
mixing latex and urea in water to form a latex/water compound.

14. The method of claim 13, wherein said step of mixing latex and urea in water comprises the step of:
adding urea at a level of approximately 2% by weight of composition.

15. The method of claim 13, wherein said step of adding urea comprises the step of:
adding urea at a level of between approximately 2% and approximately 10% by weight of composition.

16. The method of claim 13, said method further comprising the step of:
adding sodium nitrite.

17. The method of claim 13, wherein said step of mixing latex and urea in water comprises the step of:
adding urea to water to form a urea/water solution;
subsequently adding latex to said urea/water solution; and
mixing said latex in said urea/water solution to form said latex-based composition.

18. The method of claim 13, further comprising the step of:
adding compounds selected from the group consisting of fillers, pigments, emulsifiers, dispersants, and combinations thereof, to said latex-based composition.

19. A composition comprising:
at least 2% urea by weight of composition; and
sodium nitrite.

20. The composition of claim 19, wherein said at least 2% urea by weight of composition comprises between approximately 2% and approximately 10.0% urea by weight of composition.
